(19) United States
(12) Patent Application Publication
(10) Pub. No.: US 2005/0284427 A1
(43) Pub. Date: Dec. 29, 2005

(54) Free piston compressor

(76) Inventor: Eric J. Barth, Nashville, TN (US)

Correspondence Address: Michael C. Barrett, Esq.;FULBRIGHT & JAWORSKI, L.L.P., Suite 2400, 600 Congress Avenue, Austin, TX, 78701, US

(21) Appl. No.: 11/120,128

(22) Filed: May 2, 2005

Related U.S. Application Data
(60) Provisional application No. 60/567,155, filed on Apr. 30, 2004.

(51) Int. Cl. F02F 3/00

(52) U.S. Cl. 123/46 R; 123/193.6

(57) ABSTRACT

Methods and systems associated with free piston compressors. Fuel is ignited within a combustion chamber to increase pressure. A free piston is displaced within the combustion chamber. The free piston acts as an inertial load to high-pressure gas generated by combustion of the fuel. High pressure gas is pumped from the combustion chamber into a reservoir using the free piston. A spring, magnet, or other mechanism engaging the free piston may be used to assist the process. In the case of a spring, the spring assists returning the free piston to its approximate initial position as the spring expands. In the case of a magnet, the magnet may engage opposite ends of the free piston during the process. Two or more free pistons may be used. The system may be used as a power source for equipment such as a robot.

This application claims priority to, and incorporates by reference, U.S. Provisional Patent Application Ser. No. 60/567,155 entitled, “Method and System for a Compact Efficient Free Piston Compressor,” which was filed on Apr. 30, 2004.

### BACKGROUND OF THE INVENTION

I. Field of the Invention

The present invention relates to compressors. More particularly, this invention describes methods and systems for a pneumatic power source using a compact and efficient free piston compressor.

II. Description of Related Art

Batteries, internal combustion systems, and electric motors suffer from significant shortcomings. For example, these systems are heavy and therefore, do not allow for ease of mobility. Further, these systems provide limited energy storage contributing to inefficient power output and limited operation time.

Electrochemical batteries contain insufficient mass-specific energy density to perform many applications. A trade-off generally exists between the mass-specific energy density and power density of current electrochemical battery technology. Batteries that provide relatively high energy densities typically suffer from relatively low power densities, and vice-versa. Though certain high energy density batteries do exist, they are generally incapable of providing the power required for many mechanical tasks.

Electric motors are the most common type of actuator used with batteries. However, they consume electrical power in order to dissipate mechanical power. Actuators must often absorb mechanical power from a load (e.g., lowering a payload under the influence of gravity). Rather than absorb that energy, an electric motor requires electric current for instantaneous control of torque, which in turn requires electrical power to dissipate mechanical power. Electric motors are therefore energetically expensive actuators. Further, electric motors are often bulky and heavy, and are therefore not feasible for small-scale or portable devices.

Hydraulic actuators can be used to transmit hydraulic power into mechanical power, but they require a source of hydraulic power. Hydraulic power must in turn be provided by a hydraulic pump, which is typically either electrically powered (i.e., battery powered) or fuel powered (i.e., gasoline or diesel engine powered). These systems are typically too heavy for portable devices.

The referenced shortcomings are not intended to be exhaustive, but rather are among many that tend to impair the effectiveness of previously known techniques concerning compact and efficient power supply sources; however, those mentioned here are sufficient to demonstrate that the methodologies appearing in the art have not been altogether satisfactory and that a significant need exists for the techniques described and claimed in this disclosure.

### SUMMARY OF THE INVENTION

In a representative but non-limiting embodiment, the invention involves an air compressor meant as a mobile, self-contained pneumatic power supply for applications such as, but not limited to, untethered, human-scale mobile robots. Several aspects of this embodiment make it appropriate for such applications. For example, it can use conventional, high energy-density hydrocarbon fuels (such as propane, methane, CNG, gasoline, diesel fuel, and military fuels such as JP-8 and RP-1, among others) as a source of stored chemical energy. It converts this stored energy into energy stored in the form of compressed air, which is then subsequently available for pneumatic actuation or other pneumatic-powered devices (such as air tools). The usage of common hydrocarbon fuels makes the device appealing from practical, financial, safety, handling and logistics standpoints.

Additionally, the device is capable of surpassing the combined problems of low energy storage and high weight encountered with conventional robotic power supply and actuation systems, such as batteries and electric motors. This is accomplishable due to at least the following: (1) the high energy-density of the stored energy source (e.g., hydrocarbon fuels), (2) the high efficiency of the device in the conversion of chemical (fuel) to pneumatic (compressed gas) energy storage, (3) the compact and lightweight nature of the device, and (4) the compact and lightweight nature of pneumatic actuation components and their high mass and volume specific power-density relative to electromagnetic actuation.

The transduction from stored chemical to stored pneumatic energy may be accomplished via combustion and subsequent movement of a free-piston. The configuration of the device allows for the efficient conversion of heat energy (released in combustion) to kinetic energy of the free-piston. The kinetic energy of the free piston is subsequently utilized to compress air, drawn from the surroundings, into a high-pressure storage vessel. Furthermore, the configuration allows for relatively low temperature operation (compared to other combustion-based devices) via drafting in surrounding colder air into the combustion chamber briefly after the combustion event.

The configuration additionally allows for relatively silent operation by allowing the combustion chamber to descend to atmospheric pressure before an exhaust port to exhaust the combustion products. The device can utilize high-pressure compressed air from its own high-pressure storage vessel to mix stoichiometrically with gaseous or atomized liquid hydrocarbon fuels to achieve combustion without the need for an intake stroke. Likewise, a compression stroke is unnecessary given its own source of high-pressure air capable of being injected under pressure into the sealed combustion chamber.

In one embodiment of the device, the use of gaseous hydrocarbon fuels such as propane additionally allows the injection of fuel into the combustion chamber without the use of a fuel pump or complicated fuel delivery system, contributing to the lightweight nature of the device appropriate for human-scale applications. The combined effects of no required intake stroke and no required compression stroke allow for the device to start and stop on-demand with no requirement to idle as with a conventional internal combustion engine.

Additional commercial and cost appeal is realized with the device as it provides low temperature compressed gas; such a power source can be utilized through the use of standard valves and pneumatic components without the need for special considerations that other technologies may impose (such as high temperatures). The combined factors of a high-energy density fuel, the efficiency of the device, the compactness and low weight of the device, and the use of the device to drive lightweight linear pneumatic actuators (lightweight as compared with power comparable electric motors) provides at least an order of magnitude greater total system (power supply and actuation) energy density than state of the art power supply (batteries) and actuators (electric motors) appropriate for human-scale output. Embodiments of this disclosure may therefore allow for the realization of untethered, anthropomorphic humanoid robots, or mobile robots of other forms, capable of accomplishing useful amounts of work in a human environment for useful durations of time before requiring refueling. Currently, there exists no such technology. Additionally, embodiments of this disclosure operate with low noise and at low temperatures (compared to conventional internal combustion engines), and with no requirements for idling (operates on-demand).

In one embodiment, the invention involves a method in which fuel is ignited within a combustion chamber to increase pressure within the combustion chamber. A free piston is displaced within the combustion chamber. The free piston acts as an inertial load to high-pressure gas generated by combustion of the fuel. High pressure gas is pumped from the combustion chamber into a reservoir using the free piston. A spring coupled to the free piston is compressed as the free piston is displaced, and the free piston is returned to its approximate initial position as the spring expands.

In one embodiment, the invention involves another method. A first end of a free piston within a combustion chamber is engaged with a magnetic force. Fuel is ignited within the combustion chamber to increase pressure within the combustion chamber. The magnetic force is overcome, and the free piston is displaced within the combustion chamber. The free piston acts as an inertial load to high-pressure gas generated by combustion of the fuel. High pressure gas from the combustion chamber is pumped into a reservoir using the free piston. A second end of the free piston within the combustion chamber is engaged with a magnetic force, and the free piston is returned to its approximate initial position.

In one embodiment, the invention involves a system including a combustion chamber, a free piston, a high pressure reservoir, and a spring. The free piston is within the combustion chamber and is configured to be an inertial load to high-pressure gas generated by combustion of fuel within the combustion chamber. The high pressure reservoir is configured to receive high pressure gas pumped from the combustion chamber by the free piston. The spring is coupled to the free piston and is configured to compress as the free piston is displaced within the combustion chamber. The spring is configured to expand to return the free piston to its approximate initial position.

In one embodiment, the invention involves another system. The system includes a combustion chamber, a free piston, one or more magnets, and a high pressure reservoir. The free piston is within the combustion chamber. The one or more magnets are coupled to the combustion chamber. The high pressure reservoir is configured to receive high pressure gas pumped from the combustion chamber by the free piston. The one or more magnets are configured to engage a first end of the free piston with a first magnetic force. The free piston is configured to overcome the first magnetic force and become displaced within the combustion chamber. The free acts as an inertial load to high-pressure gas generated by combustion of fuel within the combustion chamber. The one or more magnets are configured to engage a second end of the free piston with a second magnetic force as the free piston reaches a maximum displacement.

The terms “a” and “an” are defined as one or more unless this disclosure explicitly requires otherwise.

The term “approximately” and its variations are defined as being close to as understood by one of ordinary skill in the art, and in one non-limiting embodiment the terms are defined to be within 10%, preferably within 5%, more preferably within 1%, and most preferably within 0.5%.

The term “high pressure” is defined according to its ordinary meaning to those having ordinary skill in the art, within its given context in this disclosure. In one non-limiting embodiment, high pressure refers to a pressure higher than atmospheric pressure and resulting from, e.g., a combustion event or reaction.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

The term “coupled,” as used herein, is defined as connected, although not necessarily directly, and not necessarily mechanically.

Other features and associated advantages will become apparent with reference to the following detailed description of specific, example embodiments in connection with the accompanying drawings.

### BRIEF DESCRIPTION OF THE DRAWINGS

The following drawings form part of the present specification and are included to further demonstrate certain aspects of the invention. The drawings do not limit the invention but simply offer examples.

FIG. 1 illustrates a compressor system, in accordance with embodiments of the present disclosure.

FIG. 2 illustrates motion of a free piston, in accordance with embodiments of the present disclosure.

FIG. 3 illustrates motion of a dual-piston, in accordance with embodiments of the present disclosure.

FIG. 4 illustrates a compressor system utilizing one or more magnets, in accordance with embodiments of the present disclosure.

### DESCRIPTION OF ILLUSTRATIVE EMBODIMENTS

The description below is directed to specific embodiments, which serve as examples only. Description of these particular examples should not be imported into the claims as extra limitations because the claims themselves define the legal scope of the invention. With the benefit of the present disclosure, those having ordinary skill in the art will comprehend that techniques claimed and described here may be modified and applied to a number of additional, different applications, achieving the same or a similar result. The attached claims cover all such modifications that fall within the scope and spirit of this disclosure.

The techniques of this disclosure can be applied to many different type of systems, including any self-powered application requiring a high energy and power density control actuator, as will be recognized by those having ordinary skill in the art.

Embodiments of this disclosure involve methods and systems for converting heat energy into energy stored in the form of compressed air that may be used for pneumatic actuation or other pneumatic-powered devices, such as air tools or untethered human-scale mobile robots. The conversion of heat energy to kinetic energy is achieved at high efficiencies due to, in part, the use of conventional liquid fuel and/or high energy-density hydrocarbon fuels, such as, but not limited to propane, methane, CNG, gasoline, diesel fuel, JP-8, RP-1 and the likes. Further, the techniques disclosed here provide efficient, compact, and lightweight pneumatic actuation components that overcome the high weight and low energy storage problems of conventional power supply and actuation systems, such as batteries and electric motors.

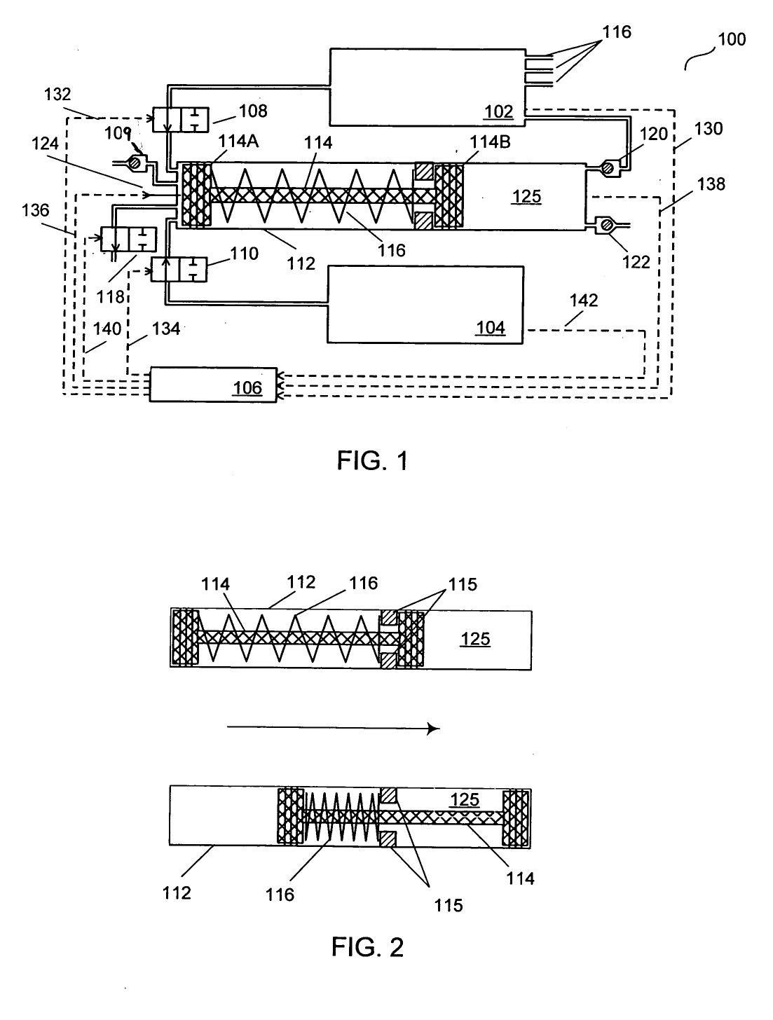

With reference to the embodiment of FIG. 1, one maintains a high-pressure supply of compressed air in a pressurized storage vessel 102 for use in pneumatic actuators or tools via air supply power ports 116. To provide such a high-pressure supply of air, the system 100 compresses atmospheric-pressure air with a free piston actuated by combustion. An example sequence of this process is described below.

Power Stroke:

High-pressure air is contained in the high-pressure storage vessel 102. High pressure fuel (e.g., liquid propane fuel) is contained in the fuel storage vessel 104. A microcontroller 106 opens the air injection valve 108, and the propane injection valve 110 for appropriate durations to fill the combustion chamber 112 with a stoichiometric mixture of fuel and oxidizer. After injection valves 108 and 110 are closed, the microcontroller 106 sends a signal to generate a spark inside the combustion chamber 112 with the spark igniter 124. Upon combustion, pressure inside the combustion chamber 112 causes the free piston 114 to move to the right. The pressure in the combustion chamber 112 pushes on the piston end 1 14A and causes the free piston 114 to accelerate. This transduction from heat to kinetic energy of the free piston 114 is energetically efficient by allowing the high-pressure combustion gases to expand completely. This is made possible by the free piston 114 presenting the high-pressure gases with an inertial load. Such an inertial load will continue to accelerate (thereby transducing heat energy into kinetic energy via the expansion of gases) while the combustion chamber pressure is above atmospheric pressure and thereby utilizes all of the available energy present as pressure times combustion chamber volume above atmospheric pressure. The techniques described here are configured to exploit this fact.

As such, the system 100 is configured with an initial combustion chamber volume such that the initial combustion pressure is capable of being reduced to atmospheric pressure within a short distance of travel of the free piston 114 such that the pressure in the compressor chamber 125 and the restoring force of the spring 16 (e.g., a light-duty return spring) are small enough to not appreciably affect the dominant loading to be inertial. In this manner, the system 100 first converts the energy present in combustion into kinetic energy in the free piston 114. Once converted into kinetic energy, the free piston 114 compresses and pumps high-pressure air present in the compressor chamber 125 into the high-pressure reservoir 102 through the check valve 120. As the free piston 114 moves to the right, the pressure in the combustion chamber 112 decreases until it is low enough to allow the check valve 109 to open and allow low temperature (relative to the combustion gases) gases to enter the combustion chamber 112.

The system 100 is configured such that the mass ratio of combustion gases to gas drawn in through check valve 109 is high such that the temperature in the combustion chamber 112 decreases, in one embodiment, to approximately 200° F. as the free-piston 114 moves to the extreme right, and thereby allows the use of standard non-high temperature components including elastomer seals on the piston ends 114A and 114B and as well as standardized valves.

Return Stroke:

Upon full travel of the free-piston 114 to the right, the spring 116 reaches full compression. The system 100 is configured such that the minimum distance between the piston end 114A and the spring stops 115 is less than the maximum compression of the spring 116 and such that the maximum restoring force of the spring 116 is the minimum possible. Alternatively, and more preferably, the spring 116 can be of the constant force variety such that the force provided is the minimum necessary to move the free-piston 114 to the left with the exhaust port valve 118 open and to open the air intake check valve 122. Additionally, the spring 116 is housed in this area so as to not add volume to the minimum combustion chamber 112 or compressor chamber 125 volumes, thereby increasing the working efficiency of the system 100.

FIG. 2 illustrates motion of free piston 114 during the power and return strokes. With the benefit of this disclosure, those having ordinary skill in the art will recognize that other mechanisms in addition to, or instead of, spring 116 may be used with system 100. For example, magnets (permanent or electromagnetic) configured as repulsive or attractive agents, brakes, and/or other latch and release mechanisms may be used. For example, in one alternative embodiment, instead of spring 116, a repulsive magnet or other mechanism may provide a force configured to return free piston 114 to its approximate starting position.

Control Signals and Operation:

In the illustrated embodiment, the microcontroller 106 operates as follows. Upon detection of a low pressure within the high-pressure air reservoir 102 via a pressure sensor and signal path 130 the microcontroller 106 initiates air and fuel injection into the combustion chamber 112. Air is first injected by opening the air injection valve 108 via signal path 132. After the air injection valve 108 is closed, the fuel injection valve 110 is opened via signal path 134. The duration of opening of the air injection valve 108 and the fuel injection valve 110 is timed by the microcontroller 106 based on an adaptive control algorithm and modeled mass flow rates such that the air/fuel mixture injected into the combustion chamber 112 is at a stoichiometric ratio and has a total mass such that the free-piston 114 will travel to the right arriving at its extreme rightmost position with a low (preferably, about zero) velocity upon combustion of the mixture (i.e. is adjusted to not “slam” into its extreme rightmost position).

Once the fuel injection valve 110 closes, the microcontroller 106 activates the spark igniter 124 via signal path 136 and the air/fuel mixture combusts within the combustion chamber 112. As the combustion gases expand and the free-piston 114 moves to the right, the pressure in the combustion chamber 112 decreases. Once the pressure in the combustion chamber 112 falls below atmospheric pressure plus the minimum cracking pressure of the breather check valve 109, cold air (relative to the combustion gases) begins to flow through the breather check valve 109 and into the combustion chamber 112, thereby cooling the gases in the combustion chamber 112. Additionally, this prevents a noisy exhaust “pop” exhibited by conventional internal combustion engines, and thereby allows for essentially silent operation.

As the piston end 114B compresses and pumps air from the compressor chamber 125 through the check valve 120 and into the high-pressure air reservoir 102, a position transducer sends position and velocity information back to the microcontroller 106 via signal path 138. This information is used by the adaptive controller within the microcontroller 106 to adjust the air and fuel to be injected for the next needed power stroke. Upon detection via signal path 138 that the piston 114 has stopped and is now proceeding again to the left, the microcontroller 106 opens the exhaust port valve 118 via signal path 140. As the free-piston 114 travels to the left under the influence of the spring 116, the diluted exhaust gases exit the combustion chamber 112 through the exhaust port valve 118. Upon detection by the microcontroller 106 via signal path 138 that the free-piston 114 has returned to the starting position (extreme left-most position), the microcontroller 106 closes the exhaust port valve 118, and the cycle is ready to begin again.

Double-Sided System:

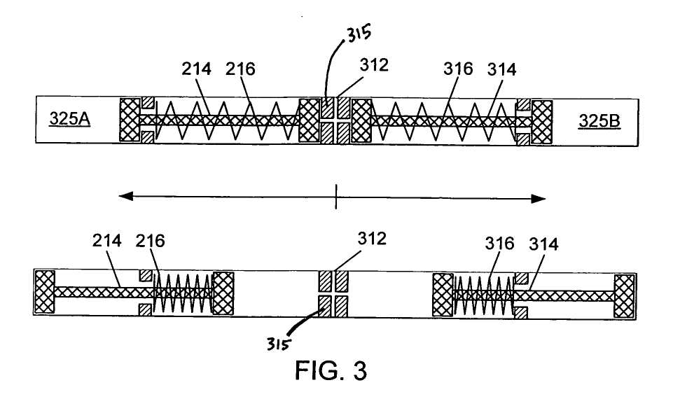

Embodiments described above are of the “single-sided” variety. Other embodiments—“double-sided” embodiments—have two opposed free-pistons and a single combustion chamber in the center of the device, as shown in FIG. 3. FIG. 3 shows compressor chambers 325A and 325B, free pistons 214 and 314, springs 216 and 316, combustion chamber 312, and spring stops 315.

The movement of double-sided embodiments is shown in FIG. 3. The operation and system schematic of this embodiment is similar to that of single-sided embodiments. The double-sided embodiments may be balanced during operation such that dynamic forces caused by the system are equal and opposite, thereby imposing zero dynamic forces as caused by the operation of the device on mounting hardware used to secure the device to a mobile or stationary platform.

Magnetic System:

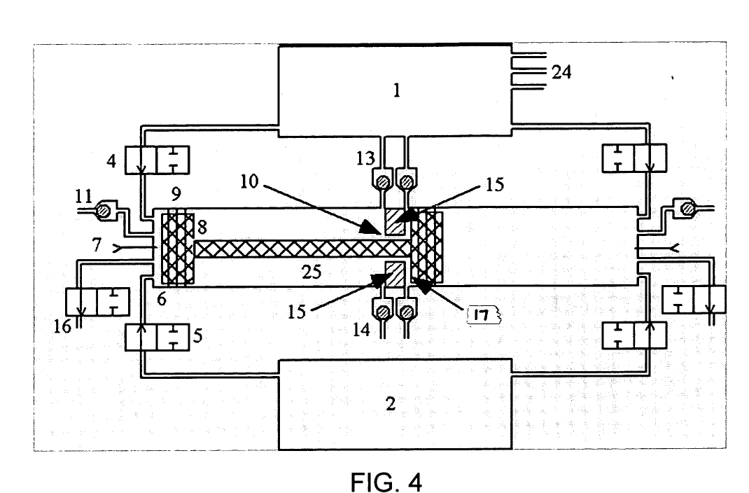

FIG. 4 illustrates a system utilizing one or more magnets instead of the spring illustrated in FIGS. 1-3. High-pressure air is contained in the high-pressure storage vessel 1. High pressure fuel (e.g., high pressure liquid propane fuel) is contained in the fuel storage vessel 2. A microcontroller (not shown for simplicity) opens the air injection valve 4 and the propane injection valve 5 for appropriate durations to fill the combustion chamber 6 with a stoichiometric mixture of fuel and oxidizer.

Magnets 15 hold the free piston 8 against the force exerted by the pressure of the air and propane before combustion. This is achieved, in one embodiment, by the free piston 8 having ferrous faces 17 on each of its ends. Magnets 15 may be permanent or electromagnetic. After injection valves 4 and 5 are closed, the microcontroller sends a signal to generate a spark inside the combustion chamber 6 with the spark igniter 7. Upon combustion, increased pressure inside the combustion chamber 6 results in a force large enough for the free piston 8 to break free from the magnets 15, thus causing the free piston 8 to move to the right. The pressure in the combustion chamber 6 pushes on the piston end 9 and causes the free piston 8 to accelerate.

This transduction from heat to kinetic energy of the free piston 8 is energetically efficient by allowing the high-pressure combustion gases to expand completely. This is made possible by the free piston 8 presenting the high-pressure gases with an inertial load. Such an inertial load will continue to accelerate (thereby transducing heat energy into kinetic energy via the expansion of gases) while the combustion chamber pressure is above atmospheric pressure and thereby utilizes all of the available energy present as pressure above atmospheric pressure. The techniques described here are configured to exploit this fact. As such, the device is configured with an initial combustion chamber volume such that the initial combustion pressure is capable of being reduced to atmospheric pressure within a short distance of travel of the free piston 8, and such that the pressure in the compressor side of the device 25 is small enough to not appreciably affect the dominant loading to be inertial. Additionally, the holding force that the magnets 15 provide decrease to a negligible value once the piston begins to move to the right. This further helps to present a dominantly inertial load to the expanding gasses for efficient operation.

It should be noted that the work required to break free from the attractive magnetic holding force is recovered once the piston moves fully to the right and re-engages the magnets on the opposite piston face. In this manner, the device first converts the energy present in combustion into kinetic energy in the free piston 8. Once converted into kinetic energy, the free piston 8 compresses and pumps high-pressure air present in the compressor side 25 of the device into the high-pressure reservoir 1 through the check valve 13. Note that rod seals located at 10 prohibit the compressed gasses from flowing to the opposite side of the device. As the free piston 8 moves to the right, the pressure in the combustion chamber 6 decreases until it is low enough to allow the check valve 11 to open and allow low temperature (relative to the combustion gases) to enter the combustion chamber 6.

The device is configured such that the mass ratio of combustion gases to gas drawn in through check valve 11 is high such that the temperature in the combustion chamber 6 decreases, in one embodiment, to approximately 200° F. as the free piston 8 moves to the extreme right, and thereby allows the use of standard non-high temperature components including elastomer seals on the piston ends and rod seals 10, and standardized valves.

Once completely to the right, the device is able to repeat operation in the opposite direction with equivalent components with equivalent roles on the opposite side. The device also has the ability to reset itself utilizing valve 4 should a combustion not result in the free piston moving to an extreme.

As the free-piston 8 moves to the left, the exhaust port valve 16 is opened such that the diluted exhaust gasses in the non-power generating side of the device can be pushed out. The check valve 14 also allows atmospheric air to be drawn in to the right compression chamber as the free-piston moves to the right (or the left compression chamber as the free-piston moves to the left).

Those having ordinary skill in the art will recognize that this system has many advantages. For example, the holding force associated with magnets 15 drops off very quickly with distance after the free piston 8 starts to move—this preserves the dominantly inertial character of the free piston 8 and helps achieves high efficiency, among other things like low noise. Additionally, the magnetic system is conservative; whatever work (energy) it takes to break away from the magnets 15, that energy may be returned when the free piston 8 latches on to the magnets 15 on the other side (thereby helping the compression phase). The system may be configured, similar to the systems described above, so that appropriate conditions may be met (e.g., an appropriate fuel amount) within the combustion chamber to ensure that the free piston's velocity is low (preferably, about zero) as it approaches a point at which magnets 15 may engage it.

With the benefit of this disclosure, those having ordinary skill in the art will recognize that other mechanisms in addition to, or instead of, magnets 15 may be used with this system or similar systems. For example, brakes and/or other latch and release mechanisms may be used.

Double-Sided Magnetic System:

The configuration of FIG. 4 can also be balanced with “double-sided” embodiments with two free pistons moving in opposite directions having one combustion chamber in the center, similar to that shown in FIG. 3.

Generation of Electric Power:

Co-generation of electric power may be incorporated into both single-sided or double-sided embodiments by integrating, e.g., a linear electromagnetic alternator within the system. In one embodiment, such an integration would require that load forces imposed by the alternator are present only after the free-piston travels the initial distance during which the heat energy is transduced into kinetic energy (i.e. to preserve the efficiency of the device, any co-generation or other parasitic loading needs to not interfere with the inertial load during expansion of the combustion gases from high pressure down to atmospheric pressure).

With the benefit of the present disclosure, those having ordinary skill in the art will recognize that one may use several types of fuel to practice the techniques of this invention. For example, liquid fuel (as opposed to gaseous fuels such as propane, methane, butane, etc) may be used. Additionally, those having ordinary skill in the art will comprehend that techniques claimed here and described above may be modified and applied to a number of additional, different applications, achieving the same or a similar result. For example, more than two free pistons may be utilized. The attached claims cover all such modifications that fall within the scope and spirit of this disclosure.

### REFERENCES

Each of the following references is incorporated by reference.

U.S. Pat. No. 1,657,641

U.S. Pat. No. 3,198,425

U.S. Pat. No. 4,085,711

U.S. Pat. No. 4,244,331

U.S. Pat. No. 4,307,997

U.S. Pat. No. 4,435,133

U.S. Pat. No. 4,602,174

U.S. Pat. No. 5,342,176

U.S. Pat. No. 6,035,637

U.S. Pat. No. 6,554,585

1. A method comprising:
igniting fuel within a combustion chamber to increase pressure within the combustion chamber;
displacing a free piston within the combustion chamber, the free piston acting as an inertial load to high-pressure gas generated by combustion of the fuel;
pumping high pressure gas from the combustion chamber into a reservoir using the free piston;
compressing a spring coupled to the free piston as the free piston is displaced; and
returning the free piston to its approximate initial position as the spring expands.

2. The method of claim 1, further comprising:
displacing an additional free piston within the combustion chamber, the additional free piston acting as an inertial load to high-pressure gas generated by combustion of the fuel;
pumping high pressure gas from the combustion chamber into a reservoir using the additional free piston;
compressing a spring coupled to the additional free piston as the additional free piston is displaced; and
returning the additional free piston to its approximate initial position as the spring expands.

3. The method of claim 2, where the free piston and additional free piston are opposed, and further comprising balancing the free pistons so that operation forces are approximately equal and opposite.

4. The method of claim 1, further comprising reducing pressure within the combustion chamber to atmospheric pressure or lower as the free piston is displaced within the combustion chamber.

5. The method of claim 4, further comprising allowing gas, having a temperature lower than combustion gas, to enter the combustion chamber when the combustion chamber pressure is reduced.

6. The method of claim 1, further comprising reducing temperature within the combustion chamber to approximately 200 F as the free piston is displaced.

7. The method of claim 1, further comprising regulating the amount of fuel introduced into the combustion chamber according to a signal reporting the free piston's velocity.

8. The method of claim 7, where the amount of fuel introduced into the combustion chamber is regulated so that the velocity of the free piston is about zero as it reaches a maximum displacement.

9. The method of claim 1, further comprising exhausting gas from the combustion chamber as the spring expands.

10. The method of claim 1, further comprising using the high pressure gas pumped into the reservoir as a source of power for equipment.

11. The method of claim 10, the equipment comprising a robot.

12. The method of claim 1, further comprising generating electricity using an alternator coupled to the free piston.

13. A method comprising:
engaging a first end of a free piston within a combustion chamber with a magnetic force;
igniting fuel within the combustion chamber to increase pressure within the combustion chamber;
overcoming the magnetic force and displacing the free piston within the combustion chamber, the free piston acting as an inertial load to high-pressure gas generated by combustion of the fuel;
pumping high pressure gas from the combustion chamber into a reservoir using the free piston;
engaging a second end of the free piston within the combustion chamber with a magnetic force; and
returning the free piston to its approximate initial position.

14. The method of claim 13, where the free piston is returned to its approximate initial position by an additional combustion event.

15. The method of claim 13, further comprising:
engaging a first end of an additional free piston within a combustion chamber with a magnetic force;
igniting fuel within the combustion chamber to increase pressure within the combustion chamber;
overcoming the magnetic force and displacing the additional free piston within the combustion chamber, the additional free piston acting as an inertial load to high-pressure gas generated by combustion of the fuel;
pumping high pressure gas from the combustion chamber into a reservoir using the additional free piston;
engaging a second end of the additional free piston within the combustion chamber with a magnetic force; and
returning the additional free piston to its approximate initial position.

16. The method of claim 15, where the free piston and additional free piston are opposed, and further comprising balancing the free pistons so that operation forces are approximately equal and opposite.

17. The method of claim 13, further comprising reducing pressure within the combustion chamber to atmospheric pressure or lower as the free piston is displaced within the chamber.

18. The method of claim 17, further comprising allowing gas, having a temperature lower than combustion gas, to enter the combustion chamber when the combustion chamber pressure is reduced.

19. The method of claim 13, further comprising reducing temperature within the combustion chamber to approximately 200 F as the free piston is displaced.

20. The method of claim 13, further comprising regulating the amount of fuel introduced into the combustion chamber according to a signal reporting the free piston's velocity.

21. The method of claim 13, further comprising using the high pressure gas pumped into the reservoir as a source of power for equipment.

22. The method of claim 21, the equipment comprising a robot.

23. The method of claim 13, further comprising generating electricity using an alternator coupled to the free piston.

24. A system comprising:
a combustion chamber;
a free piston within the combustion chamber, the free piston configured to be an inertial load to high-pressure gas generated by combustion of fuel within the combustion chamber;
a high pressure reservoir configured to receive high pressure gas pumped from the combustion chamber by the free piston; and
a spring coupled to the free piston, the spring being configured to compress as the free piston is displaced within the combustion chamber and configured to expand to return the free piston to its approximate initial position.

25. The system of claim 24, further comprising:
an additional free piston within the combustion chamber, the additional free piston configured to be an inertial load to high-pressure gas generated by combustion of fuel within the combustion chamber; and
an additional spring coupled to the additional free piston, the additional spring being configured to compress as the additional free piston is displaced within the combustion chamber and configured to expand to return the additional free piston to its approximate initial position.

26. The system of claim 24, further comprising a microcontroller configured to regulate an amount of fuel introduced into the combustion chamber according to the free piston's velocity.

27. The system of claim 26, where the microcontroller regulates the amount of fuel introduced into the combustion chamber so that a velocity of the free piston is about zero as it reaches a maximum displacement.

28. The system of claim 24, further comprising equipment coupled to the high pressure reservoir, the equipment obtaining power using the high pressure reservoir.

29. The system of claim 28, the equipment comprising a robot.

30. The system of claim 24, further comprising an alternator coupled to the free piston and configured to generate electricity.

31. A system comprising:
a combustion chamber;
a free piston within the combustion chamber;
one or more magnets coupled to the combustion chamber; and
a high pressure reservoir configured to receive high pressure gas pumped from the combustion chamber by the free piston;
where the one or more magnets are configured to engage a first end of the free piston with a first magnetic force;
where the free piston is configured to overcome the first magnetic force and become displaced within the combustion chamber, the free piston acting as an inertial load to high-pressure gas generated by combustion of fuel within the combustion chamber; and
where the one or more magnets are configured to engage a second end of the free piston with a second magnetic force as the free piston reaches a maximum displacement.

32. The system of claim 31, where the second magnetic force is an attractive force.

33. The system of claim 31, where the second magnetic force is a repulsive force.

34. The system of claim 31, further comprising:
an additional free piston within the combustion chamber;
an additional one or more magnets coupled to the combustion chamber; and
where the additional one or more magnets are configured to engage a first end of the additional free piston with a third magnetic force;
where the additional free piston is configured to overcome the third magnetic force and become displaced within the combustion chamber, the additional free piston acting as an inertial load to high-pressure gas generated by combustion of fuel within the combustion chamber; and
where the additional one or more magnets are configured to engage a second end of the additional free piston with a fourth magnetic force as the additional free piston reaches a maximum displacement.

35. The system of claim 31, further comprising a microcontroller configured to regulate an amount of fuel introduced into the combustion chamber according to the free piston's velocity.

36. The system of claim 31, further comprising equipment coupled to the high pressure reservoir, the equipment obtaining power using the high pressure reservoir.

37. The system of claim 36, the equipment comprising a robot.

38. The system of claim 31, further comprising an alternator coupled to the free piston and configured to generate electricity.
